(19) United States
(12) Patent Application Publication
(10) Pub. No.: US 2026/0250568 A1
(43) Pub. Date: Aug. 27, 2026

(54) HEAT-TRANSFER FLUIDS BASED ON AT LEAST PARTIALLY RE-REFINED LUBRICATING OILS

(71) Applicant: TOTALENERGIES ONETECH, COURBEVOIE (FR)

(72) Inventors: Paula USSA ALDANA, SOLAIZE (FR); Arnaud RONCELIN, SOLAIZE (FR); David KUPIEC, SOLAIZE (FR)

(21) Appl. No.: 18/872,462

(22) PCT Filed: Jun. 9, 2023
(86) PCT No.: PCT/EP2023/065462

§ 371 Date: Dec. 6, 2024

(30) Foreign Application Priority Data
Jun. 13, 2022 (FR) FR2205651

(51) Int. Cl. C09K 5/10; F28F 23/00

(52) U.S. Cl. CPC C09K 5/10; F28F 23/00

(57) ABSTRACT

The present application relates to the use of a composition based on at least one at least partially re-refined lubricating oil as a heat-transfer fluid. The application also relates to a method for transferring heat into a mobile or stationary mechanical system, comprising at least one step of circulating, in said mechanical system, a composition based on at least one at least partially re-refined lubricating oil as a heat-transfer fluid. The application also relates to a device for transferring heat or for thermal management, wherein a composition based on at least one at least partially re-refined lubricating oil is implemented as a heat-transfer fluid.

### TECHNICAL FIELD

The present invention relates to the field of heat-transfer fluids. More specifically, the present invention relates to the use of re-refined lubricating oils for formulating heat-transfer fluids.

### PRIOR ART

Heat-transfer fluids find use in a wide range of systems in which they allow heat to be transported between different temperature sources.

These fluids are typically used in heat exchangers, for example cooling systems for thermal or electric engines, such as vehicle engines, refrigerators, boilers, air conditioners, thermal solar collectors, radiators in electrical circuits, especially in the case of high-power electrical transformers, electronic transformers, coal-fired, oil-fired, gas-fired or nuclear thermal power plants, and wastewater heat exchangers.

A great many heat-transfer fluids have been documented and marketed, employing a wide variety of base fluids and performance additives.

In general, heat-transfer fluids must meet two requirements: firstly, they must be able to transfer heat energy efficiently and, secondly, it is essential that the heat-transfer fluid does not degrade the system in which it is used, or does not itself degrade during use.

The efficiency of heat transfer essentially depends on the thermo-physical properties of the base fluid, in particular the specific heat capacity, thermal conductivity, density, and viscosity of the fluid, but also on the hydraulic performance of the heat-transfer fluid. Thus, a heat-transfer fluid must remain pumpable over the temperature range in which it must circulate in a given system. The viscosity and the viscosity profile with temperature of the heat-transfer fluid thus determine its hydraulic performance.

Water is commonly used as base liquid for heat-transfer fluids, by virtue of its natural availability and lack of environmental impact of its use. Indeed, water is an excellent carrier of thermal energy by virtue of its high specific heat capacity, high thermal conductivity, and low viscosity. A significant limitation on the use of water as a heat-transfer fluid is that it freezes at a relatively high temperature of 0° C., making it unsuitable for use in many systems requiring operating temperatures below 0° C. In addition, water-based heat-transfer fluids are naturally corrosive and can cause significant damage to the systems in which they operate. To overcome these limitations, a great many heat-transfer fluids have been developed in which freezing-point depressants are added to water to lower its freezing temperature, as well as various additives to control corrosion.

Mineral oils from petroleum refining have also been proposed as base liquids for heat-transfer fluids, in particular for applications in systems in which the fluid is liable to be heated to high temperatures.

One example is document U.S. Pat. No. 7,972,999, which proposes to use a base oil prepared from a paraffin wax to form a heat-exchange liquid, and having in particular an auto-ignition temperature greater than 329° C. and a high viscosity index.

However, a large amount of crude oil is generally required to obtain refined oils. Typically, the extraction of 1 liter of refined oil requires 37 liters of crude oil. Petroleum refining processes are also very energy intensive. Current environmental protection and resource conservation issues are however pushing manufacturers to propose alternatives to conventional oils that are more eco-friendly.

There thus remains a need to provide heat-transfer fluids that are more environmentally friendly while at the same time having excellent physicochemical properties or even improved properties compared to known heat-transfer fluids.

### SUMMARY OF THE INVENTION

The present invention aims to propose novel heat-transfer fluids that meet these expectations. More particularly, the inventors have discovered that recycled lubricating base oils are particularly suitable for use as heat-transfer fluids.

Thus, according to a first of its aspects, the invention relates to the use of a composition based on at least one at least partially re-refined lubricating oil as a heat-transfer fluid. In the context of the present invention, the expression “at least partially re-refined lubricating oil”, also referred to more simply hereinafter as “re-refined oil”, “regenerated oil” or “recycled oil”, refers to oil derived at least in part from a used lubricating composition that has been subjected to one or more treatment steps known as re-refining treatment.

In accordance with the invention, “used lubricating composition” (or more simply “used lubricant” or “used lubricating oil”) is understood as meaning any lubricating composition that has been used for lubricating moving parts, in particular metal parts, of a mechanical system, such as, but not limited to, rolling-element bearings, gears or engines.

Used lubricating oil can come from various sources. In particular, as detailed hereinafter, it may be a lubricant that has been used for the lubrication of a drive system, in particular a “mobile” system, or for the lubrication of an industrial system, in particular a “stationary” system.

As a consequence of their origin, used lubricating oils, in particular engine lubricating oils, contain a number of degradation products derived from the oil itself or from additives contained therein, as well as metal particles and particles of metal oxides and other elements, for example from the engine. Used oil may in particular contain a high content of undesirable elements, for example of calcium (Ca), iron (Fe), magnesium (Mg), sodium (Na), nickel (Ni), phosphorus (P), silicon (Si), chlorine (Cl), zinc (Zn), etc.

Methods for re-refining or reconditioning used lubricating oils have been developed in order to regenerate these oils and permit their subsequent reuse.

A re-refined lubricating oil is thus an oil obtained from one or more steps of treating a used lubricant with the aim of removing, at least in part, a number of the contaminants present therein, such as dust, water, fuel fractions, metallic elements, and other residues resulting from the degradation of additives present in the lubricant.

To the knowledge of the inventors, it has never been proposed to use a recycled lubricating oil for formulating a heat-transfer fluid.

The use according to the invention of a re-refined lubricating oil as a heat-transfer liquid has proven advantageous in a number of respects.

Firstly, as illustrated in the examples that follow, the inventors have shown that re-refined lubricating oils have especially advantageous thermo-physical properties, particularly in terms of volatility, density, viscosity index, flash point, and thermal conductivity, that make them particularly suitable as heat-transfer fluids.

Surprisingly, the recycled lubricating oils even have thermo-physical properties for use as a heat-transfer fluid that are superior to those of refined base oils, in other words virgin or new base oils.

Unlike re-refined lubricating oils, a refined base oil, also referred to as “virgin” or “new” base oil, is an oil directly derived from petroleum refining that has not yet been used.

Secondly, the use of recycled lubricating oils as heat-transfer fluids advantageously meets current expectations of reducing environmental impact and conserving resources. Thus, the use of heat-transfer fluids based on regenerated lubricating oils makes it possible to advantageously reduce the carbon footprint of the products by comparison with the use of virgin base oils.

As detailed hereinafter, said re-refined lubricating oil(s) may be used as a heat-transfer fluid as is, i.e. on their own, in other words without additivation. In one particular embodiment, the invention thus relates to the use as a heat-transfer fluid of at least one at least partially re-refined lubricating oil.

Said re-refined lubricating oil(s) may in addition be used in combination with one or more other ingredients. They may in particular be additized with one or more additives, for example additives intended to boost the compatibility of the heat-transfer fluid with the materials of the system for which it is intended, such as, but not limited to, anti-corrosion additives, antioxidant additives, etc.

In this alternative embodiment, the heat-transfer fluid according to the invention is advantageously formed predominantly of said re-refined lubricating oil(s). In particular, said re-refined lubricating oil(s) may represent more than 80% by weight of the total weight of the heat-transfer fluid, in particular more than 90% by weight and more particularly more than 95% by weight, of the total weight of the heat-transfer fluid.

Said re-refined lubricating oil(s) may also be used in combination with at least one new base oil.

The present invention also relates to the use of at least one at least partially re-refined lubricating oil for formulating or preparing a heat-transfer fluid.

It also relates to a process or method for preparing a heat-transfer fluid comprising at least one step consisting of obtaining an at least partially re-refined lubricating oil from a used lubricant.

The process for preparing a heat-transfer fluid according to the invention may comprise more particularly the steps consisting of:
(i) preparing an at least partially re-refined lubricating oil from a used lubricant;
(ii) optionally mixing said at least partially re-refined lubricating oil with one or more new base oils different from the re-refined lubricating oils, for example one or more mineral oils; and
(iii) optionally supplementing said at least partially re-refined lubricating oil from step (i), or the mixture of lubricating oils from step (ii), with at least one additive selected in particular from anti-corrosion additives, friction-modifying additives, extreme-pressure additives, anti-wear additives, detergents, antioxidants, viscosity index (VI) improvers, pour-point depressants (PPDs), dispersants, defoamers, and mixtures thereof.

The heat-transfer fluid formulated according to the invention based on at least one re-refined lubricating oil may be used for multiple applications, in particular as a liquid coolant for a vehicle engine, as a heat-transfer liquid in an air conditioning or heating circuit of a building, etc.

Examples of applications of fluids formulated according to the invention are described more particularly hereinafter.

In particular, the invention additionally relates, according to another of its aspects, to the use of a heat-transfer fluid according to the invention that is based on at least one at least partially re-refined lubricating oil as a liquid coolant in a mobile or stationary drive system, in particular as a liquid coolant for a vehicle engine, for example an electric or hybrid vehicle.

Other characteristics, variants and advantages of the use of at least partially re-refined lubricating oils for the formulation of a heat-transfer fluid according to the invention will become clearer on reading the description and the examples that follow, which are given by way of illustration and without limitation of the invention.

The expressions “between . . . and . . . ”, “ranging from . . . to . . . ”, “formed of . . . to . . . ” and “varying from . . . to . . . ” should be understood as limits inclusive, unless otherwise stated. In the description and the examples, percentages are percentages by weight unless otherwise indicated. Percentages are thus expressed by weight relative to the total weight of the composition.

### DETAILED DESCRIPTION

### At Least Partially Re-Refined Lubricating Oil

As previously stated, the oil used for the formulation of a heat-transfer fluid according to the invention is an at least partially re-refined lubricating oil, also referred to as “regenerated oil” or “recycled oil”; in other words, a lubricating oil derived from a used lubricating composition that has been subjected to one or more re-refining treatment steps may be used according to the invention.

It is understood that a used lubricating composition may be a mixture of more than one used lubricating composition originating from the same source or from more than one different source.

The used lubricating compositions and consequently the regenerated lubricating oils comprise, in a majority amount, one or more base oils commonly used in the field of lubricants, such as mineral, synthetic or natural, animal or vegetable oils or mixtures thereof. This may be a mixture of more than one base oil, for example a mixture of two, three or four base oils.

These base oils may be natural in origin, for example oils derived from plants or animals, such as vegetable, animal or fish oils and mixtures thereof. Examples of such oils are rapeseed oil, canola oil, tall oil, sunflower oil, soybean oil, hemp oil, olive oil, linseed oil, mustard oil, palm oil, peanut oil, castor oil, coconut oil, animal fats, and mixtures thereof.

These base oils are advantageously oils of mineral or synthetic origin belonging to groups I to V according to the classes defined in the API classification (or their equivalents according to the ATIEL classification) and presented in the table below, or mixtures thereof.

TABLE 1

| | Saturates | Sulfur | Viscosity index |
|---|---|---|---|
| | content | content | (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydrocracked or | | | |
| hydroisomerized oils | | | |

| | |
|---|---|
| Group IV | Polyalphaolefins (PAOs) |
| Group V | Esters and other base oils not |
| | included in groups I to IV |

In particular, the used lubricating composition from which the regenerated lubricating oil used according to the invention is derived may comprise at least 50% by weight of base oil(s) relative to its total weight, in particular at least 60% by weight of base oil(s), and more particularly between 60% and 99% by weight of base oil(s).

The re-refined lubricating oils used according to the invention advantageously have characteristics, in terms of content of saturated compounds, content of sulfur, and viscosity index, that satisfy the criteria defined by the API classification for oils of groups I, II, III, IV and/or V, in particular for oils of groups I, II, III and/or IV.

An aim of the invention is thus to use, as a heat-transfer fluid, a composition formed in whole or in part of at least one at least partially re-refined lubricating oil and obtained after one or more steps of treating a used lubricant that is based on one or more oils of groups I to V according to the API classification.

According to one particular embodiment, the re-refined lubricating oil used according to the invention may result from the treatment of a used lubricating composition that had been used for lubricating a drive system, in particular a “mobile” system, i.e. including light vehicles, heavy-duty vehicles, mobile “off-road” machines or marine vehicles.

According to another particular embodiment, the re-refined lubricating oil used according to the invention may result from the treatment of a used lubricating composition that had been used for lubricating an industrial system, in particular a “stationary” system, that is to say including, but not limited to, turbines, compressors, hydraulic systems, gears or forming or cutting machines.

A used lubricating composition from which the regenerated lubricating oil used according to the invention is derived may contain various additives common in the field of lubricants, such as friction-modifying additives, extreme-pressure additives, anti-wear additives, detergents, antioxidants, viscosity index (VI) improvers, pour-point depressants (PPDs), dispersants, defoamers, thickeners, and mixtures thereof.

As already mentioned previously, the properties of the used lubricating composition are degraded as a consequence of its use, for a period of varying length, for lubricating and/or cooling a mechanical system, in particular a drive system, such as a combustion engine.

Thus, on account of their origin, the used lubricating compositions may contain one or more additives described above and impurities resulting from the degradation of additives originally present in the lubricant, or resulting from wear of moving mechanical parts.

The composition of the used lubricant may of course vary according to the origin of the lubricant, the initial formulation thereof and on account of variation in contamination depending on what it had been used for.

The regenerated lubricating oil used according to the invention originates more particularly from a used lubricating composition that has been subjected to one or more prior pretreatment steps known in the field of re-refining of used lubricants.

In particular, these treatment steps aim to at least partially remove water, solid particles, fuel and/or other contaminants, such as polycyclic aromatic hydrocarbons (PAHs), that are undesirable in lubricant formulations.

According to one particular embodiment, the regenerated lubricating oil used according to the invention originates from a used lubricant that has been subjected to one or more prior steps of dehydration, distillation, filtration, hydrogenation, liquid/liquid extraction, settling and/or of passing the used lubricant over an adsorbent material, preferably as detailed below.

Thus, the invention relates to the use, as a heat-transfer fluid, of a composition based on at least one at least partially re-refined lubricating oil, in particular one formed of at least one at least partially re-refined lubricating oil, preferably an oil as described above, said at least partially re-refined lubricating oil having been obtained from a used lubricating composition that has been subjected to at least one or more steps of dehydration, distillation, filtration, hydrogenation, liquid/liquid extraction, settling and/or passing said used lubricating composition over an adsorbent material, preferably carried out under the conditions detailed below.

It is preferable that the regenerated lubricating oil used according to the invention is obtained by subjecting a used lubricating composition to at least one dehydration step. This dehydration step removes any water that may be present in the used lubricant.

The regenerated lubricating oil used according to the invention thus advantageously has a water content of less than or equal to 10% by weight, in particular less than or equal to 5% by weight, especially less than or equal to 2% by weight, and more particularly less than or equal to 1% by weight, relative to the total weight of said regenerated lubricating oil.

This dehydration may be carried out by any method known to those skilled in the art, for example by distillation, evaporation, settling, heating or by passing a stream of hot air through the used lubricating composition.

According to one embodiment, the dehydration step may be carried out at a temperature of between 50° C. and 250° C., preferably between 100° C. and 200° C. In particular, it may be carried out at a pressure of between 50 000 and 150 000 Pa, preferably at atmospheric pressure.

It is preferable that the regenerated lubricating oil used according to the invention is obtained by subjecting a used lubricating composition to at least one prior filtration step. This filtration may be performed by any method known to those skilled in the art. This filtration step may or may not be a particle filtration step. It may for example be performed by systems of the diatomaceous earth type.

It is preferable that the regenerated lubricating oil used according to the invention is obtained by subjecting a used lubricating composition to at least one distillation step, which preferably follows a prior dehydration step. Said distillation step(s) may be performed by any technique known to those skilled in the art. These include, for example, distillation at atmospheric pressure and distillation under reduced pressure. The distillations may for example be carried out at a temperature of between 100° C. and 500° C., preferably between 200° C. and 400° C., more preferably between 300° C. and 380° C. In particular, they may be carried out at a pressure of between 25 and 2000 Pa, preferably between 50 and 1000 Pa, more particularly between 50 and 250 Pa.

The regenerated lubricating oil used according to the invention is advantageously obtained by subjecting a used lubricating composition to at least one prior step of passing said used lubricating composition over an adsorbent material.

The adsorbent material advantageously permits the selective adsorption of aromatic compounds, in particular PAHs.

In particular, passage over an adsorbent material, preferably over activated carbon, advantageously makes it possible to reduce the content of polycyclic aromatic hydrocarbons (PAHs), selected in particular from chrysene, benzo[b]fluoranthene, benzo[j]fluoranthene, benzo[k]fluoranthene, benzo[e]pyrene, benzo[a]pyrene, dibenz[a,h]anthracene and/or benz[a]anthracene, of the used lubricating composition.

The expression “passing the used lubricating composition over an adsorbent material” is understood as meaning flow of the used lubricating composition over the adsorbent support. The adsorbent materials may be, for example, activated carbon, zeolites, clays or functionalized porous compounds. It is preferably activated carbon.

For example, the regenerated lubricating oil used in the process of the invention may be obtained from the treatment of a used lubricating composition according to the process described in document WO 2018/109208.

In the case of passing the used lubricating composition over activated carbon, the amount of activated carbon used is preferably between 0.5 and 60 g of activated carbon per liter of used lubricating composition, preferably between 0.5 and 50 g/L, preferably from 1 to 50 g/L, preferably between 1 and 30 g/L, for example between 5 and 60 g/L, preferably between 5 and 50 g/L.

The flow rate during passage of the used lubricating composition may be between 1 m³/h and 15 m³/h, for example between 5 and 10 m³/h.

The activated carbon is preferably characterized by a density of between 200 and 500 kg/m³, measured for example in accordance with the ASTM D2854 standard.

The activated carbon is preferably a coal-based carbon, preferably comprising from 70 to 95%, advantageously from 80 to 90% by weight, of carbon.

The step of passing the used lubricating composition over an adsorbent support, preferably over activated carbon, is advantageously preceded by the following prior steps:
one or more distillation steps; and
a filtration step, in particular as defined above.

The regenerated lubricating oil used according to the invention may advantageously be obtained by subjecting a used lubricating composition to at least one prior hydrogenation (or hydrotreating) step, which preferably follows a prior dehydration and/or distillation step. Said hydrogenation step(s) may be performed by any technique known to those skilled in the art and generally consist of treating the lubricating oil with hydrogen, generally in the presence of a hydrotreating catalyst. Such a catalyst may contain for example at least one oxide or sulfide of at least one group VI metal and/or of at least one group VIII metal, such as molybdenum, tungsten, nickel or cobalt, and a support, for example alumina, silica-alumina or a zeolite.

The regenerated lubricating oil used according to the invention may advantageously be obtained by subjecting a used lubricating composition to at least one prior step of liquid/liquid extraction with a solvent, which preferably follows a prior dehydration and/or distillation step. In particular, liquid/liquid extraction with a solvent advantageously makes it possible to lighten a dark-colored used oil and to eliminate at least in part the bad odor or content of aromatic compounds, in particular PAHs. Said extraction step(s) may be performed by any technique known to those skilled in the art. The extraction is usually carried out in a mixer-settler or extraction column, using a suitable extraction solvent.

The regenerated lubricating oil used according to the invention may advantageously be obtained by subjecting a used lubricating composition to at least one prior settling step. Said settling step(s) may be performed by any technique known to those skilled in the art.

It is understood that the invention is in no way limited to the use of regenerated oils obtained according to the treatment methods described above. Other at least partially re-refined lubricating oils, for example group I and/or II oils, resulting from treatment steps different from those described above, may be suitable for the invention.

In any event, a re-refined lubricating oil used according to the invention differs from a used lubricating oil in particular because of the reduced content of certain undesirable contaminating elements, for example water, fuel, metallic elements or certain heteroatoms. A regenerated lubricating oil used according to the invention is characterized in particular by a silicon content of between 0 ppm and 300 ppm, especially between 1 and 300 ppm. A regenerated lubricating oil used according to the invention is characterized in particular by a phosphorus content of less than or equal to 100 ppm, in particular between 0 ppm and 100 ppm, for example 0 ppm.

A regenerated lubricating oil used according to the invention may also be characterized by its content of one or more other elements selected from chlorine, oxygen, and nitrogen. It may for example have a chlorine content of between 0 ppm and 50 ppm, for example of 0 ppm.

The content of these elements can be evaluated by any method known to those skilled in the art, for example by X-ray fluorescence (XRF), or by infrared or ultraviolet spectroscopy.

On the other hand, because of its formation from a used lubricant, a regenerated lubricating oil used according to the invention differs both in its composition and its physicochemical properties from virgin or new base oil, from oil directly derived from petroleum refining, and from native base oils, for example oils of natural origin.

In particular, as indicated previously, a regenerated lubricating oil surprisingly has excellent thermo-physical and hydraulic properties, particularly in terms of viscosity index, density, Noack volatility, flash point and/or thermal conductivity, and advantageously has thermo-physical and hydraulic properties superior to those of a virgin base oil.

The regenerated lubricating oil used according to the invention preferably has a kinematic viscosity, measured at 100° C. in accordance with the ASTM D445 standard, of between 2 and 12 mm²/s⁻¹, in particular of between 3 and 10 mm²/s⁻¹.

It is preferable that the kinematic viscosity, measured at 100° C. in accordance with the ASTM D445 standard, of the at least partially re-refined lubricating oil is greater than or equal to 5 mm²/s, for example between 5 and 12 mm²/s, more particularly between 5 and 10 mm²/s. The regenerated lubricating oil used according to the invention advantageously has a kinematic viscosity, measured at 40° C. in accordance with the ASTM D445 standard, of between 20 and 40 mm²/s, in particular between 25 and 35 mm²/s.

It is preferable that a regenerated lubricating oil used according to the invention has a viscosity index of greater than or equal to 110. The viscosity index of the at least partially re-refined lubricating oil may thus be between 110 and 130, in particular between 112 and 125.

The viscosity index can in particular be determined in accordance with the NF ISO 2909 standard.

A regenerated lubricating oil used according to the invention preferably has a Noack volatility of less than or equal to 15%. The Noack volatility of the at least partially re-refined lubricating oil may thus be between 8% and 15%.

More preferably, a regenerated lubricating oil used according to the invention has a Noack volatility of strictly less than 12%. The Noack volatility of the at least partially re-refined lubricating oil may thus be between 8% and 11.9%.

The Noack volatility can in particular be determined in accordance with the CEC L-40-93 standard.

A regenerated lubricating oil used according to the invention preferably has a sulfur content of between 0.02% and 0.2% by weight relative to the total weight of said regenerated lubricating oil.

A regenerated lubricating oil used according to the invention preferably has a content of aromatic compounds of greater than or equal to 0.5% by weight, in particular greater than or equal to 1% by weight, relative to the total weight of said regenerated lubricating oil. The content of aromatic compound(s) in the regenerated lubricating oil may thus be between 1% and 25% by weight, in particular between 2.5% and 20% by weight, relative to the total weight of said regenerated lubricating oil.

The contents of these various elements can be determined according to any method known to those skilled in the art, for example by X-ray fluorescence (XRF), or by infrared or ultraviolet spectroscopy.

The re-refined lubricating oil used according to the invention advantageously has at least one, at least two, at least three, or even all of the following characteristics:
a kinematic viscosity, measured at 100° C. in accordance with the ASTM D445 standard, of greater than or equal to 5 mm²/s, for example between 5 and 12 mm²/s, more particularly between 5 and 10 mm²/s;
a viscosity index of greater than or equal to 110, especially between 110 and 130, in particular between 112 and 125;
a Noack volatility of less than or equal to 15%, in particular between 8% and 15%, preferably strictly less than 12%, more particularly between 8% and 11.9%;
a sulfur content of between 0.01% and 0.3% by weight, in particular between 0.02% and 0.2% by weight, relative to the total weight of said regenerated lubricating oil;
a content of aromatic compound(s) of greater than or equal to 0.5% by weight, especially greater than or equal to 1% by weight, in particular between 1% and 25% by weight, more particularly between 2.5% and 20% by weight, relative to the total weight of said regenerated lubricating oil.

A regenerated lubricating oil used according to the invention advantageously has a density of less than or equal to 870 kg/m³, in particular less than or equal to 860 kg/m³. The density of the at least partially re-refined lubricating oil may thus be between 830 and 870 kg/m³, in particular between 840 and 860 kg/m³.

The density can in particular be determined in accordance with the NF EN ISO 12185 standard.

A regenerated lubricating oil used according to the invention advantageously has a flash point greater than or equal to 225° C., in particular greater than or equal to 228° C. The flash point of the at least partially re-refined lubricating oil may thus be between 225° C. and 245° C.

The flash point can in particular be determined in accordance with the NF EN ISO 2592 standard.

A regenerated lubricating oil used according to the invention advantageously has a thermal conductivity, measured at 100° C. and at atmospheric pressure, of greater than or equal to 125 mW/mK, in particular greater than or equal to 128 mW/mK. The thermal conductivity of the at least partially re-refined lubricating oil may thus be between 125 and 145 mW/mK, in particular between 128 and 140 mW/mK.

The thermal conductivity can in particular be determined in accordance with the ASTM D7896-19 standard.

On account of these properties, in terms of viscosity index, density, thermal conductivity, flash point, Noack volatility, and density, the re-refined lubricating oils used according to the invention have excellent performance both in terms of heat transfer efficiency and hydraulic performance, and advantageously enhanced performance by comparison with virgin base oils.

A high viscosity index makes it possible in particular to provide a heat-transfer fluid in which the viscosity shows little variation with temperature, thus ensuring good hydraulic properties in the heat-transfer fluid. Thus, the heat-transfer fluid according to the invention may be used in systems that may be subjected to large variations in temperature, for example as a liquid coolant in vehicles, and remains pumpable over the temperature range in which it must circulate in said system.

In particular, the re-refined lubricating oils advantageously have a low density, in particular a density lower than that of virgin base oils, and a high viscosity index, in particular a viscosity index higher than that of virgin base oils, which makes it possible to reduce pumping costs while having better thermal properties.

### Heat-Transfer Fluid

As mentioned previously, said re-refined lubricating oil(s) used according to the invention, in particular ones as defined and characterized above, may be used as a heat-transfer fluid as is, or may be formulated into a composition intended for use as a heat-transfer fluid.

The composition used as heat-transfer fluid may thus comprise one or more base oils different from the at least partially re-refined lubricating oil and/or one or more additives.

In one particular embodiment, said re-refined lubricating oil(s) may be formulated in combination with one or more different base oils, in particular one or more new base oils.

They are in particular selected from the base oils commonly used in the field of lubricants, such as mineral, synthetic or natural, animal or vegetable oils or mixtures thereof.

These base oils are advantageously oils of mineral or synthetic origin belonging to groups I to V according to the classes defined in the API classification (or equivalents thereof according to the ATIEL classification) and presented in Table 1 above, or mixtures thereof. A composition used according to the invention according to the invention may thus comprise, or even be formed of, a mixture of one or more at least partially re-refined lubricating oils and one or more new base oils, for example at least one mineral oil.

In particular, a composition used according to the invention may comprise between 0% and 80% by weight, in particular between 5% and 75% by weight, of new base oil(s) different from the re-refined lubricating oils necessary according to the invention and defined above, relative to the total weight of the composition.

According to one particular embodiment, a composition used as a heat-transfer fluid according to the invention comprises less than 50% by weight of new base oil(s) different from the re-refined lubricating oils.

It is preferable that a composition used as a heat-transfer fluid according to the invention is formed predominantly of said re-refined lubricating oil(s). In particular, said re-refined lubricating oil(s) advantageously represent(s) more than 80% by weight of the total weight of the heat-transfer fluid, in particular more than 90% by weight and more particularly more than 95% by weight of the total weight of the heat-transfer fluid.

Thus, a composition used as a heat-transfer fluid according to the invention advantageously comprises more than 80% by weight, in particular between 90% and 100% by weight, more particularly between 95% and 100% by weight, of at least one at least partially re-refined lubricating oil, relative to the total weight of the composition.

In one particular embodiment, a composition used as a heat-transfer fluid according to the invention is completely free of base oil different from the re-refined lubricating oils.

In one particular embodiment, a composition used as a heat-transfer fluid according to the invention may comprise, in addition to said re-refined lubricating oil(s), one or more additives that are intended in particular to boost the compatibility of the heat-transfer fluid with the materials of the system for which it is intended.

These additives may be selected in particular from anti-corrosion additives, friction-modifying additives, extreme-pressure additives, anti-wear additives, detergents, antioxidants, viscosity index (VI) improvers, pour-point depressants (PPDs), dispersants, defoamers, and mixtures thereof.

These additives may be added to said regenerated base oil(s) used according to the invention, or to the mixture of said regenerated base oil(s) and at least one new base oil, in an appropriate amount determined by a person skilled in the art. It is understood that the nature and amount of the additives used are selected such that the advantageous properties, as a heat-exchange fluid, of the composition based on said re-refined lubricating oil(s) are unaffected or largely unaffected by the envisaged addition.

A composition used as a heat-transfer fluid according to the invention may comprise between 0% and 20% by weight, in particular between 0.01% and 10% by weight, of additives, in particular additives as described above, relative to the total weight of the composition.

Thus, according to another of its aspects, the invention relates to a process or method for preparing a heat-transfer fluid comprising at least one step consisting of obtaining an at least partially re-refined lubricating oil from a used lubricant.

Such a process or method advantageously comprises at least the steps consisting of:
(i) providing an at least partially re-refined lubricating oil obtained from a used lubricant, in particular one formed by subjecting a used lubricant to at least one or more steps of dehydration, distillation, filtration, hydrogenation, liquid/liquid extraction, settling and/or of passing the used lubricant over an adsorbent material, preferably as detailed above;
(ii) optionally mixing said at least partially re-refined lubricating oil with one or more new base oils different from the re-refined lubricating oils, for example one or more mineral oils; and
(iii) optionally supplementing said at least partially re-refined lubricating oil from step (i), or the mixture of lubricating oils from step (ii), with at least one additive, in particular one as described above.

### Applications

As mentioned above, an at least partially re-refined lubricating oil is particularly suitable for use as a heat-transfer fluid by virtue of its thermo-physical properties.

In particular, a fluid based on at least one re-refined lubricating oil according to the invention may be used for various systems and applications, and in one or more heat-transfer fluid circuits in particular, as a substitute for conventional heat-transfer fluids.

Heat-transfer fluid circuits conventionally comprise means for forced or free circulation of the heat-transfer fluid, for example a pump or any other equivalent means, and dissipation means, for example exchangers or any other equivalent means of heat diffusion.

The invention is thus not limited to a particular application of the fluids formulated according to the invention, the development that follows being given solely by way of illustration and without limitation.

In particular, the present invention relates to the use of a composition based on at least one at least partially re-refined lubricating oil as a heat-transfer fluid, also referred to as a heat-exchange liquid, in a mobile or stationary mechanical system, in other words for the transfer of heat in a mobile or stationary mechanical system.

A fluid according to the invention may for example be used to ensure heat exchange in “stationary” mechanical systems, such as boilers, air conditioners, particularly in data centers, thermal solar collectors, photovoltaic solar collectors, radiators in electrical circuits, especially electrical transformers, coal-fired, oil-fired, gas-fired or nuclear thermal power plants, wastewater heat exchangers, turbines, compressors, hydraulic systems, gears, or forming or cutting machines.

A fluid according to the invention may for example also be used to ensure heat exchange in “mobile” mechanical systems, including components of light vehicles, heavy-duty vehicles, mobile “off-road” machines or marine vehicles, particularly in the drive systems thereof.

The invention relates in particular to a process or method for the transfer of heat in a mobile or stationary mechanical system, in particular one as described above, comprising at least one step of circulating around said mechanical system, as a heat-transfer fluid, a composition based on at least one at least partially re-refined lubricating oil, in particular one as described above.

Such a process or method comprises in particular the steps consisting of:
a) providing a composition comprising, or even being formed of, at least one at least partially re-refined lubricating oil, in particular one as defined above;
b) employing said composition from step a) in a mechanical system, in particular one as described above, more particularly in one or more heat-transfer fluid circuits; and
c) circulating said composition to ensure heat exchange during operation of said mechanical system.

According to an advantageous embodiment, the fluid formulated according to the invention based on at least one re-refined lubricating oil is used as liquid coolant.

As an illustration of possible application, the fluid formulated according to the invention may be used as a liquid coolant for moving parts in a mechanical system, and more particularly in a mobile or stationary drive system.

A heat-transfer fluid based on at least one re-refined lubricating oil according to the invention may thus be used as a liquid coolant for cooling gears, rolling-element bearings, bearings such as roller or sliding bearings, or engines.

A “drive system” is understood for the purposes of the present invention as meaning a system comprising all the mechanical parts necessary for the mobile or stationary application concerned and including at least one engine. It may be a combustion, gas, in particular hydrogen, ammonia, electric or hybrid drive system, according to the nature of the engine(s) included in the drive system: combustion engine, gas engine, in particular hydrogen engine, ammonia engine and/or electric engine.

A “propulsion system” is understood for the purposes of the present invention as meaning a system comprising the mechanical parts necessary for the propulsion of a vehicle. The propulsion system more particularly encompasses an engine, for example an electric engine comprising the rotor-stator assembly of the power electronics (dedicated to speed regulation), a transmission and optionally a battery. The battery is itself generally made up of a set of electric accumulators termed cells.

Likewise, a heat-transfer fluid based on at least one re-refined lubricating oil according to the invention may be used as a liquid coolant for cooling the battery present in an electric or hybrid vehicle.

As an example of application, a heat-transfer fluid according to the invention based on at least one re-refined lubricating oil may be used for cooling a propulsion system of an electric or hybrid vehicle, and more particularly of the engine, the power electronics, the transmission and/or the battery.

In another application variant, a fluid according to the invention based on at least one re-refined lubricating oil may be used as a liquid coolant in metalworking, such as working with aluminum, steel, stainless steel, galvanized steel or yellow metals, in particular in any metal machining operation, for example in shaping, cutting or joining processes or any other transformation of metal such as forming, stamping, rolling, etc.

Such compositions used in metal machining processes are also commonly referred to as “metalworking compositions or fluids”, “machining fluids” or “cutting fluids”.

In another application variant, a fluid according to the invention based on at least one re-refined lubricating oil may be used in particular as a liquid coolant in a hydraulic system. It thus ensures heat transfer between the various components of a hydraulic system, particularly in hydraulic actuators (cylinders/engines) or machine assemblies, when required.

Finally, with regard to the rheological properties of re-refined lubricating oils used according to the invention, a composition according to the invention based on at least one re-refined lubricating oil may be used concurrently as a heat-transfer fluid, in particular as a liquid coolant, and as a lubricant, for all the mechanical systems described above, for example in a propulsion system of an electric or hybrid vehicle and/or in a hydraulic system.

Specifically, a composition according to the invention based on at least one re-refined lubricating oil makes it possible to concurrently achieve good properties in terms of cooling and lubricating parts of such mechanical systems, particularly in a propulsion system of an electric or hybrid vehicle, such as an electric engine in an electric or hybrid vehicle.

According to another of its aspects, the present invention also relates to a heat-transfer or thermal-management device in which a composition based on at least one at least partially re-refined lubricating oil is used as a heat-transfer fluid.

In particular, the device employs at least one heat-transfer or thermal-management circuit in which the composition based on at least one at least partially re-refined lubricating oil is used.

In accordance with the invention, the particular, advantageous or preferred characteristics of these oils or compositions make it possible to define uses according to the invention that are likewise particular, advantageous or preferred.

The invention will now be described by means of the examples that follow, which are given by way of illustration and without limitation of the invention.

### Example

### Method of Measuring Kinematic Viscosity

The kinematic viscosity of the oils is measured at 40° C. (KV40) and at 100° C. (KV100) using a viscometer, in accordance with the NF EN ISO 3104 standard. This standard is technically equivalent to the ASTM D445 standard. The results are expressed in mm²/s (equivalent to centistokes, denoted cSt).

### Method of Measuring Volatility

The volatility is used to determine the loss through evaporation of oils at high temperatures. It is determined by the Noack volatility test, carried out in accordance with the CEC L-40-93 standard. In the test, the oil sample is subjected to a constant flow of air heated to approximately 250° C., for approximately 60 minutes. The result is expressed as the fraction of weight lost, in percent by weight.

### Method of Measuring Density

The density of the oils is measured at 15° C. using a U-tube density meter, in accordance with the NF EN ISO 12185 standard. It is expressed in kg/m³.

### Method of Measuring the Viscosity Index

The viscosity index is a dimensionless ratio that gives an indication of the variation of the viscosity of oils with temperature. It is calculated from the kinematic viscosity values at 40° C. and at 100° C., in accordance with the NF ISO 2909 standard. The higher this index, the less the viscosity of the oils is influenced by variations in temperature.

### Method of Measuring Thermal Conductivity

Thermal conductivity, often denoted λ, characterizes the ability of the oil to diffuse heat into media. It is measured by a transient hot-wire liquid thermal conductivity method, in accordance with the ASTM D7896-19 standard. It is expressed in mW/mK.

### Method of Measuring Flash Point

The flash point gives an indication of the ability of a product to form a flammable mixture with air under controlled conditions. It is determined using a Cleveland open-cup apparatus, in accordance with the NF EN ISO 2592 standard. The flash point at ambient atmospheric pressure is the lowest temperature at which passing a flame above the test cup containing the oil causes the vapor above the surface of the liquid to ignite. It is expressed in degrees Celsius.

### Method of Measuring the Content of Sulfur and of Aromatic Compounds

The contents of sulfur and of aromatic compounds in the oil are determined by infrared or ultraviolet spectroscopy.

### Example 1

The properties of six commercially available re-refined lubricating oils I1 to I6 that were in accordance with the invention were evaluated.

These oils are obtained from used base oils that have undergone at least one step of dehydration, distillation, filtration, hydrogenation, liquid/liquid extraction, settling and/or of passing the used lubricant over an adsorbent material, in particular at least one step of dehydration, distillation, liquid/liquid extraction and/or hydrogenation.

Also evaluated were three new lubricating oils C1 to C3 that were not in accordance with the invention, on account of not having undergone any recycling or re-refining step.

These oils are commercially available group I or II base oils according to the API classification.

In particular, the kinematic viscosities at 40° C. and 100° C., viscosity index, density, volatility, flash point, and thermal conductivity of these oils were measured according to the protocols detailed above.

The results are presented below in Table 2 for the re-refined and virgin oils that had characteristics equivalent to those defined by the API classification for group I base oils and in Table 3 for the re-refined and virgin oils that had characteristics equivalent to those defined by the API classification for group II base oils.

TABLE 2

| Oil | I1 | I2 | I3 | I4 | I5 | C1 |
|---|---|---|---|---|---|---|
| KV40 [mm²/s] | 33.0 | 27.9 | 29.4 | 26.5 | 29.1 | 31.3 |
| KV100 [mm²/s] | 5.9 | 5.2 | 5.4 | 5.0 | 5.4 | 5.3 |
| Viscosity index | 122 | 118 | 118 | 114 | 119 | 102 |
| Density [kg/m³] | 849.3 | 851 | 854.1 | 850.9 | 854.1 | 872.5 |
| Noack volatility [%] | 7.2 | 9.4 | 11.6 | 10.6 | — | 13.1 |
| Flash point [° C.] | 236 | 228 | 230 | 230 | 228 | 224 |
| Thermal conductivity | 131.3 | 129.3 | — | 131.4 | 128.4 | 124.3 |
| [mW/mK] | | | | | | |
| Sulfur content [%] | 0.11 | 0.16 | 0.06 | 0.06 | 0.15 | 0.26 |
| Aromatics content [%] | 7.2 | — | 12.5 | 17.5 | 9.8 | 15 |

TABLE 3

| Oil | I6 | C2 | C3 |
|---|---|---|---|
| KV40 [mm²/s] | 28.2 | 30.1 | — |
| KV100 [mm²/s] | 5.6 | 5.4 | 5.0 |
| Viscosity index | 120 | 115 | — |
| Density [kg/m³] | 849.5 | 852.8 | — |
| Noack volatility [%] | 10.9 | 12 | — |
| Flash point [° C.] | 230 | 222 | — |
| Thermal conductivity [mW/mK] | 133.2 | 126.7 | 127.6 |
| Sulfur content [%] | 0.02 | <0.0003 | <0.001 |
| Aromatics content [%] | 9 | 0.4 | 0.002 |

### Results

All the at least partially re-refined oils necessary according to the invention have a higher viscosity index and thermal conductivity and a lower density by comparison with virgin oils unsuitable for the invention and having otherwise equivalent properties.

The at least partially re-refined oils consequently have especially advantageous thermo-physical properties that make it possible to achieve performances as heat-transfer fluids superior to those of new lubricating oils that have not undergone any recycling.

A lower density and a high viscosity index also make it possible to ensure good hydraulic performance and in particular to reduce the costs associated with pumping these oils when using them as a heat-transfer fluid. In addition, the at least partially re-refined oils have properties better than those of new lubricating oils in terms of savings on energy and on fuel in particular.

Moreover, the at least partially re-refined oils necessary according to the invention have reduced volatility and a higher flash point by comparison with those measured for oils that are unsuitable for the invention. The at least partially re-refined oils consequently permit enhanced safety by comparison with new lubricating oils.

In conclusion, an at least partially re-refined lubricating oil has especially advantageous properties, in particular properties superior to those of a new oil, that allow it to be used as a heat-transfer fluid, especially as a liquid coolant.

1-13. (canceled)

14. A method comprising circulating a heat-transfer fluid comprising a regenerated lubricating oil in a heat-transfer circuit to transport heat between different temperature sources.

15. The method of claim 14, further comprising forming the regenerated lubricating oil by subjecting a used lubricating oil to one or more of a dehydration process, a distillation process, a filtration process, a hydrogenation process, a liquid/liquid extraction process, a settling process or of passing the used lubricant over an adsorbtion process.

16. The method of claim 14, wherein the regenerated lubricating oil has a kinematic viscosity, measured at 100° C. in accordance with the ASTM D445 standard, of from 5 mm²/s to 12 mm²/s.

17. The method of claim 14, wherein the regenerated lubricating oil has a viscosity index of from 110 to 130.

18. The method of claim 14, wherein the regenerated lubricating oil has a Noack volatility of between 8% and 15%.

19. The method of claim 14, wherein the regenerated lubricating oil has a sulfur content of between 0.02% and 0.2% by weight, relative to the total weight of the regenerated lubricating oil.

20. The method of claim 14, wherein the regenerated lubricating oil has a content of aromatic compound(s) of between 1% and 25% by weight, relative to the total weight of the regenerated lubricating oil.

21. The method of claim 14, wherein the regenerated lubricating oil has a density of between 830 kg/m³ and 870 kg/m³.

22. The method of claim 14, wherein the regenerated lubricating oil has a thermal conductivity, measured at 100° C. and at atmospheric pressure, of between 125 mW/mK and 145 mW/mK.

23. The method of claim 14, wherein the heat transfer fluid further comprises one or more fresh base oils and/or one or more additives selected from anti-corrosion additives, friction-modifying additives, extreme-pressure additives, anti-wear additives, detergents, antioxidants, viscosity index (VI) improvers, pour-point depressants (PPDs), dispersants, defoamers, and mixtures thereof.

24. The method of claim 14, wherein the heat transfer fluid comprises more than 80% by weight of the regenerated lubricating oil, relative to the total weight of the heat transfer fluid.

25. The method of claim 14, wherein the heat transfer fluid comprises from 95% to 100% by weight of the regenerated lubricating oil, relative to the total weight of the heat transfer fluid.

26. The method of claim 14, wherein the heat transfer circuit is included in a mobile or stationary mechanical system.

27. The method of claim 14, wherein the regenerated lubricating oil comprises a regenerated group I to group V base oil as defined by the API classification.

28. The method of claim 14, wherein one of the temperature sources comprises a heat exchanger or radiator configured to cool the heat exchange fluid.

29. A heat-transfer or thermal-management device comprising:
a heat transfer fluid comprising a regenerated lubricating oil;
a fluid circuit;
a pump configured to pump the heat transfer fluid through the fluid circuit; and
a heat exchanger or radiator disposed on the fluid circuit and configured to cool the heat exchange fluid.
